(19) United States
(12) Patent Application Publication
(10) Pub. No.: US 2026/0233570 A1
(43) Pub. Date: Aug. 13, 2026

(54) EXTENDABLE CHASSIS LEVELING

(71) Applicant: Oshkosh Corporation, Oshkosh, WI (US)

(72) Inventor: Wenton S. Miller, Oshkosh, WI (US)

(73) Assignee: Oshkosh Corporation, Oshkosh, WI (US)

(21) Appl. No.: 19/532,656

(22) Filed: Feb. 6, 2026

Related U.S. Application Data
(60) Provisional application No. 63/755,880, filed on Feb. 7, 2025.

(51) Int. Cl. B60G 17/017; B60G 7/00; B60G 17/015; B60G 17/019; B60K 7/00; B62D 5/04

(52) U.S. Cl. CPC B60G 17/017; B60G 7/001; B60G 17/0152; B60G 17/019; B60K 7/0007; B62D 5/0418; B60G 2202/416; B60G 2204/8304; B60G 2300/06

(57) ABSTRACT

A lift device includes a chassis including a center frame section, a turntable supported on and rotatably coupled to the center frame section, a boom assembly coupled to the turntable, a platform coupled to the boom assembly so that the boom assembly is configured to selectively raise and lower the platform, a frame section including a pair of axle arms coupled to the a mounting hub so that the pair of axle arms are extendable relative to the center frame section, and an oscillating axle assembly coupled between the mounting hub and the center frame section, so that the frame section is allowed to pivot relative to the center frame section about a pivot axis.

### CROSS-REFERENCE TO RELATED PATENT APPLICATIONS

This application claims the benefit of and priority to U.S. Provisional Patent Application No. 63/755,880, filed on Feb. 7, 2025, which is incorporated herein by reference in its entirety.

### BACKGROUND

Vehicles typically include a chassis that supports one or more tractive elements (e.g., wheels, tracks, etc.).

### SUMMARY

In some aspects, the present disclosure relates to a lift device, including: a chassis including a center frame section; a turntable supported on and rotatably coupled to the center frame section; a boom assembly coupled to the turntable; a platform coupled to the boom assembly so that the boom assembly is configured to selectively raise and lower the platform; an axle arm coupled to the center frame section so that the axle arm is extendable relative to the center frame section; a tractive element coupled to the axle arm by a leveling assembly; and a steering spindle coupled to the tractive element; the leveling assembly includes: a cylinder directly coupled to or integrally formed with the steering spindle; a rod at least partially arranged within the cylinder and extending outwardly from the cylinder, wherein the rod includes a piston arranged within the cylinder that divides an internal volume of the cylinder into a first chamber and second chamber; and a steering actuator coupled between the axle arm and the cylinder.

In some aspects, the present disclosure relates to a lift device, including: a chassis; a turntable supported on and rotatably coupled to the chassis; a boom assembly coupled to the turntable; a platform coupled to the boom assembly so that the boom assembly is configured to selectively raise and lower the platform; an axle arm coupled to the chassis so that the axle arm is extendable relative to the chassis between a retracted position and an expanded position; a tractive element coupled to the axle arm by a leveling assembly; and a drive hub assembly coupled to the tractive element, wherein the drive hub assembly includes a steering spindle and a drive motor; the leveling assembly includes: a cylinder coupled to the drive hub; a rod at least coupled to the cylinder and extending at least partially into the cylinder, wherein the rod includes a piston arranged within the cylinder that divides an internal volume of the cylinder into a first chamber and second chamber; and a steering actuator coupled between the axle arm and the drive hub assembly.

In some aspects, the present disclosure relates to a lift device, including: a chassis including a center frame section; a turntable supported on and rotatably coupled to the center frame section; a boom assembly coupled to the turntable; a platform coupled to the boom assembly so that the boom assembly is configured to selectively raise and lower the platform; an axle arm coupled to the center frame section so that the axle arm is extendable relative to the center frame section; a tractive element coupled to the axle arm by a leveling assembly; a steering spindle coupled to the tractive element; the leveling assembly includes: a cylinder directly coupled to or integrally formed with the steering spindle; and a rod at least partially arranged within the cylinder and extending outwardly from the cylinder, wherein the rod includes a piston arranged within the cylinder that divides an internal volume of the cylinder into a first chamber and second chamber; and a controller configured to selectively supply fluid to or remove fluid from the first chamber and the second chamber to raise or lower the cylinder, and thereby the tractive element, relative to the axle arm.

The invention is capable of other embodiments and of being carried out in various ways. Alternative exemplary embodiments relate to other features and combinations of features as may be generally recited in the claims.

### BRIEF DESCRIPTION OF THE DRAWINGS

The invention will become more fully understood from the following detailed description taken in conjunction with the accompanying drawings wherein like reference numerals refer to like elements, in which:

FIG. 1 is a perspective view of a lift device, according to an exemplary embodiment;

FIG. 2 is a schematic illustration of the lift device of FIG. 1 with an axle assembly in a retracted position, according to an exemplary embodiment;

FIG. 3 is a schematic illustration of the lift device of FIG. 1 with an axle assembly in an extended position, according to an exemplary embodiment;

FIG. 4 is a schematic illustration of a top view of the lift device of FIG. 1 including an oscillating axle assembly, according to an exemplary embodiment;

FIG. 5 is a schematic illustration of a front view of the oscillating axle assembly of FIG. 4, according to an exemplary embodiment;

FIG. 6 is a schematic illustration of a top view of the lift device of FIG. 1 including an oscillating axle assembly, according to an exemplary embodiment;

FIG. 7 is a schematic illustration of a front view of the oscillating axle assembly of FIG. 6, according to an exemplary embodiment;

FIG. 8 is a schematic illustration of an actuator assembly installed on an oscillating axle assembly in a vertical orientation, according to an exemplary embodiment;

FIG. 9 is a schematic illustration of an actuator assembly installed on an oscillating axle assembly in an angled or horizontal orientation, according to an exemplary embodiment;

FIG. 10 is a schematic illustration the lift device of FIG. 1 including a leveling assembly with a tractive element in a neutral position, according to an exemplary embodiment;

FIG. 11 is a perspective view of the leveling assembly of FIG. 10, according to an exemplary embodiment;

FIG. 12 is a cross-sectional view of the leveling assembly of FIG. 11, according to an exemplary embodiment;

FIG. 13 is a front view of the cross-section of FIG. 12, according to an exemplary embodiment;

FIG. 14 is a block diagram of a leveling assembly of the lift device of FIG. 1, according to an exemplary embodiment;

FIG. 15 is a block diagram of a control system of the lift device of FIG. 1 including a leveling assembly, according to an exemplary embodiment;

FIG. 16 is a schematic illustration the lift device of FIG. 1 including the leveling assembly of FIG. 10 with a tractive element displaced downwardly, according to an exemplary embodiment;

FIG. 17 is a schematic illustration the lift device of FIG. 1 including the leveling assembly of FIG. 10 with a tractive element displaced downwardly, according to an exemplary embodiment;

FIG. 18 is a schematic illustration the lift device of FIG. 1 including the leveling assembly of FIG. 10 accommodating for side-to-side or front-to-rear height differences, according to an exemplary embodiment;

FIG. 19 is a schematic illustration the lift device of FIG. 1 including the leveling assembly of FIG. 11 accommodating for side-to-side or front-to-rear height differences, according to an exemplary embodiment;

FIG. 20 is a perspective view of a leveling assembly for the lift device of FIG. 1, according to an exemplary embodiment;

FIG. 21 is a cross-sectional view of the leveling assembly of FIG. 20, according to an exemplary embodiment;

FIG. 22 is a front view of the cross-section of FIG. 21, according to an exemplary embodiment;

FIG. 23 is a schematic illustration the lift device of FIG. 1 including the leveling assembly of FIG. 20 accommodating for side-to-side or front-to-rear height differences, according to an exemplary embodiment;

FIG. 24 is a perspective view of a lift device including in-line extendable axles, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

In general, conventional large lift devices (e.g., mobile elevated work platform (MEWP)) with X-frame expandable axle chassis do not allow oscillating axle or independent height adjustment (e.g., leveling) functionality because the axle arms are only allowed to pivot or rotate about a single axis, which enables the expandable functionality. The use of the term “large lift devices” herein relates to lift devices with a maximum platform height of greater than 90 ft, or greater than 100 ft, or greater than 150 feet, or greater than 160 feet, or greater than 170 feet, or greater than 180 feet. The systems and methods of the present disclosure provide an oscillating axle assembly where individual frame sections are pivotable or rotatably coupled to a center frame section, so the each individual frame section is allowed to oscillate relative to the center frame section. According to an exemplary embodiment, a leveling assembly may alternatively or additionally be coupled between each of the tractive elements and the axle arm coupled thereto. The leveling assembly may further provide oscillating axle functionality and/or independent leveling or height-adjusting functionality to each of the axle arms.

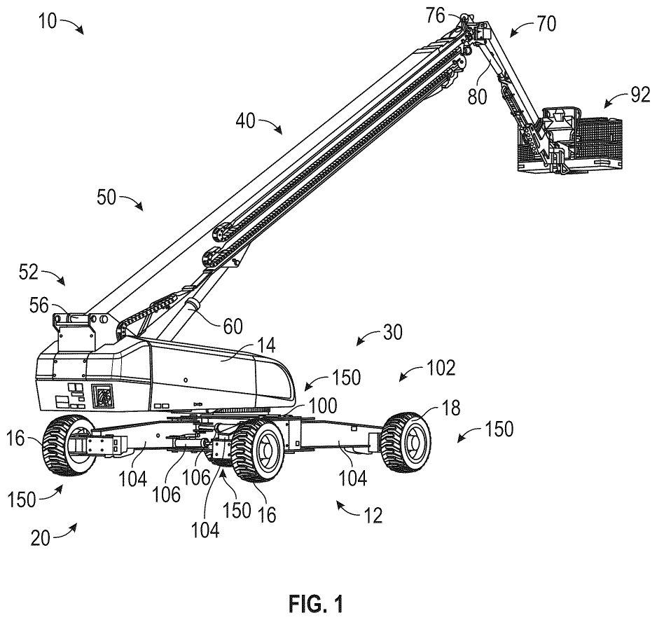

According to the exemplary embodiment shown in FIG. 1, a vehicle (e.g., a lift device, an aerial work platform, a telehandler, a boom lift, a scissor lift, etc.), shown as lift device 10, includes a lift base or frame, shown as chassis 12. In other embodiments, the lift device 10 is another type of vehicle (e.g., a fire apparatus, a military vehicle, an airport rescue fire fighting (“ARFF”) truck, a boom truck, a refuse vehicle, a forklift, a crane, an excavator, an agricultural vehicle, etc.). The chassis 12 supports a rotatable structure, shown as turntable 14, and a boom assembly or telescoping boom, shown as boom 40. According to an exemplary embodiment, the turntable 14 is rotatable relative to the chassis 12. According to an exemplary embodiment, the turntable 14 includes a counterweight positioned at a rear of the turntable 14. In other embodiments, the counterweight is otherwise positioned and/or at least a portion of the weight thereof is otherwise distributed throughout the lift device 10.

A first end, shown as front end 20, of the chassis 12 is supported by a first plurality of tractive elements, shown as front tractive elements 16, and an opposing second end, shown as rear end 30, of the chassis 12 is supported by a second plurality of tractive elements, shown as rear tractive elements 18. According to the exemplary embodiment shown in FIG. 1, the front tractive elements 16 and the rear tractive elements 18 include wheels. In other embodiments, the front tractive elements 16 and/or the rear tractive elements 18 include track assemblies.

As shown in FIG. 1, the boom 40 is coupled to a jib 70 at a distal end of the boom 40. By way of example, the boom 40 may include a plurality of telescoping boom sections that are configured to extend and retract along a longitudinal centerline thereof to selectively increase and decrease a length of the boom 40. In other embodiments, the boom 40 may include one or more sections that articulate with respect to one another (e.g., an articulating boom).

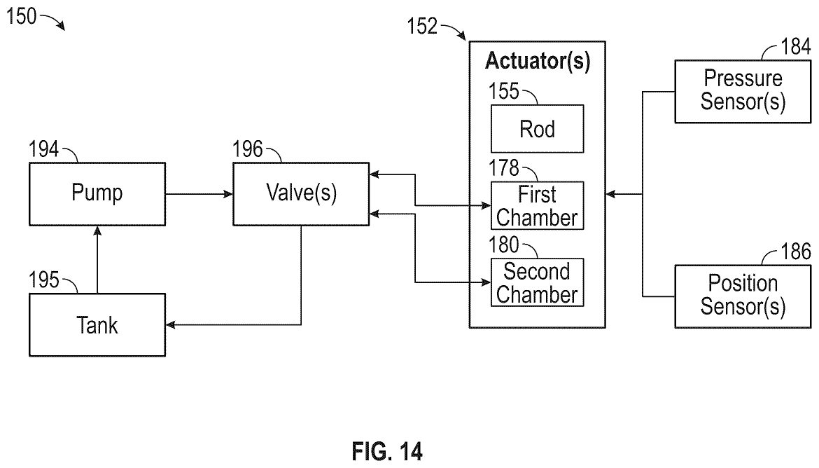

As shown in FIG. 1, the boom 40 has a first end (e.g., lower end, a proximal end, etc.), shown as base end 52 that is pivotally coupled (e.g., pinned, etc.) to the turntable 14 at a joint, shown as lower boom pivot 56. The boom 40 includes a first actuator (e.g., pneumatic cylinder, electric actuator, hydraulic cylinder, etc.), shown as lower lift cylinder 60 (see, e.g., FIG. 14). The lower lift cylinder 60 has a first end coupled to the turntable 14 and an opposing second end coupled to the boom 40. According to an exemplary embodiment, the lower lift cylinder 60 is positioned to raise and lower the boom 40 relative to the turntable 14 about the lower boom pivot 56.

As shown in FIG. 1, the boom 40 includes an implement, shown as platform assembly 92, coupled to an end of the jib 70. As shown in FIG. 1, the boom 40 includes a second actuator (e.g., pneumatic cylinder, electric actuator, hydraulic cylinder, etc.), shown as jib cylinder 80. According to an exemplary embodiment, the jib cylinder 80 is positioned to actuate (e.g., lift, rotate, elevate, etc.) the jib 70 and the platform assembly 92 relative to the boom 40 about the pivot 76. In some embodiments, the platform assembly 92 may be removed and/or replaced with an implement or a robotic assembly.

According to an exemplary embodiment, the platform assembly 92 is a structure that is particularly configured to support one or more workers. In some embodiments, the platform assembly 92 includes an accessory or tool that may be accessed by a worker. Such tools may include pneumatic tools (e.g., impact wrench, airbrush, nail gun, ratchet, etc.), plasma cutters, welders, spotlights, etc. In some embodiments, the platform assembly 92 includes a control panel to control operation of the lift device 10 (e.g., the turntable 14, the tractive elements 16, 18, the boom 40, etc.) from the platform assembly 92. In other embodiments, the platform assembly 92 includes or is replaced with an accessory and/or tool (e.g., forklift forks, etc.).

According to an exemplary embodiment, the lift device 10 includes a prime mover that is supported by the chassis 12. In some embodiments, the prime mover may be within the turntable 14. The prime mover provides power to the various components of the lift device 10 (e.g., the lower lift cylinder 60, the jib cylinder 80, the tractive elements 16, 18, steering actuators/motors. etc.). In some embodiments, the prime mover is in the form of an internal combustion engine. In some embodiments, the prime mover is in the form of one or more electric motors powered by an energy storage system (e.g., a battery, a battery pack, a plurality of battery packs, etc.). In some embodiments, the electric motors may be powered by a fuel cell that, in some configurations, supplies power in conjunction with one or more battery packs that supply the peak power.

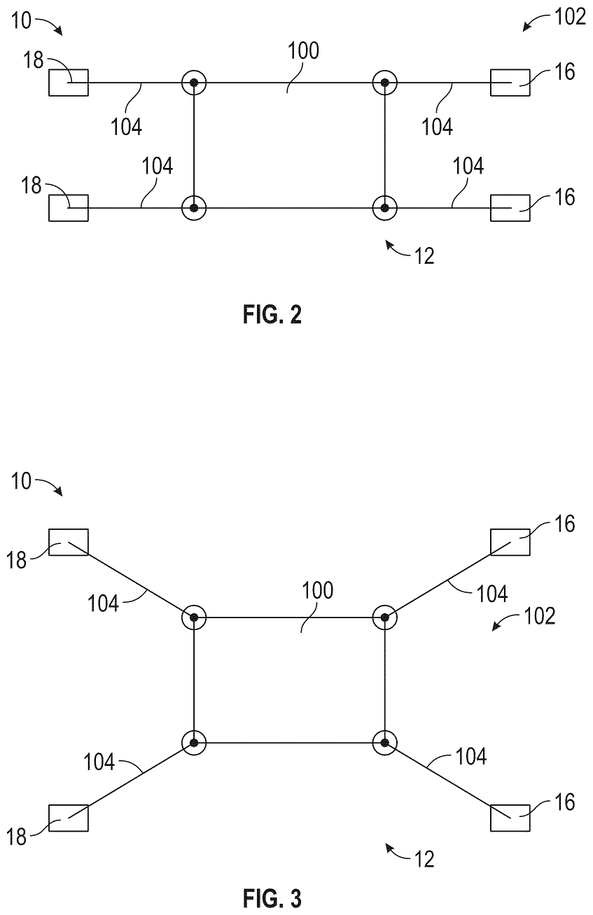

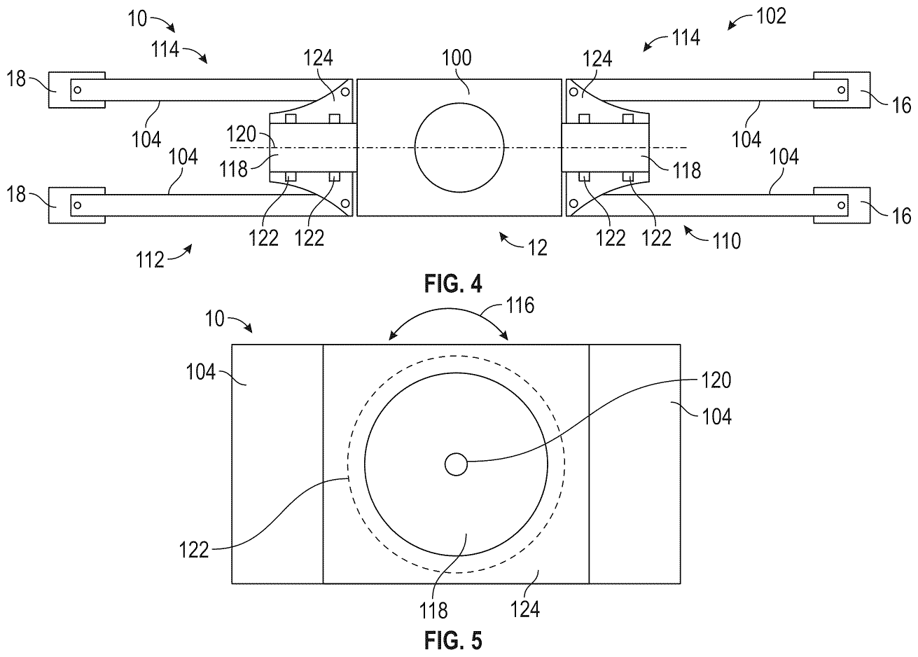

With continued reference to FIGS. 1-3, the chassis 12 of the lift device 10 includes a center frame section 100 and an axle assembly 102 that is coupled to and extends outwardly from the center frame section 100. According to an exemplary embodiment, the axle assembly 102 includes an axle arm 104 coupled between each of the tractive elements 16, 18 and the center frame section 100. Each of the axle arms 104 is pivotably or rotatably coupled to the center frame section 100 so that each of the axle arms 104 is expandable relative to the center frame section 100. For example, the axle assembly 102 may be movable between a retracted position (see, e.g., FIG. 2) where the axle arms 104 are retracted toward a longitudinal centerline or axis (e.g., toward the pivot axis 120 of FIG. 4) and/or under the center frame section 100, and an expanded position where the axle arms 104 are expanded outwardly from the center frame section 100 and away from the longitudinal centerline or axis (e.g., away from the pivot axis 120 of FIG. 4) to define a generally X-shaped geometry. That is, the chassis 12 of the lift device 10 defines an X-frame, variable geometry, or expandable chassis. In some embodiments, each of the axle arms 104 is coupled to an expanding actuator 106 that is coupled between the center frame section 100 and the corresponding axle arm 104 (see, e.g., FIG. 1). The expanding actuators 106 are configured to selectively move the axle arms 104 between the retracted position and the expanded position.

According to an exemplary embodiment, the chassis 12 of the lift device 10 may include individual frame sections that are coupled to the center frame section 100 by an oscillating axle assembly that enables the individual frame sections to oscillate (e.g., pivot or rotate) relative to the center frame section 100. For example, FIGS. 4 and 5 show an exemplary embodiment of the chassis 12 including a front frame section 110 and a rear frame section 112. Both the front frame section 110 and the rear frame section 112 are rotatably coupled to the center frame section 100 by an oscillating axle assembly 114, so that the front frame section 110 and the rear frame section 112 are allowed to oscillate (e.g., pivot or rotate about an oscillating direction 116 as illustrated in FIG. 5) relative to the center frame section 100.

In general, the oscillating axle assembly 114 is designed similarly on the front and rear of the center frame section 100. Accordingly, the following description of a single oscillating axle assembly 114 applies to both couplings to the front frame section 110 and the rear frame section 112. According to an exemplary embodiment, the oscillating axle assembly 114 includes a tube, pin, or post 118 that extends outwardly from the center frame section 100 (e.g., in a direction toward the tractive elements 16, 18) along a pivot axis 120, and one or more bearings 122 rotatably coupled to an outer periphery or surface of the post 118. In some embodiments, the post 118 defines a generally cylindrical shape. In some embodiments, the bearings 122 are in the form of tapered roller bearings. In some embodiments, the bearings 122 are in the form of turntable bearings or another equivalent bearing that allows relative rotation between the frame sections and the post 118. In some embodiments, the bearings 122 include a combination of axial and radial bearings having different sizes. According to an exemplary embodiment, the post 118 is rotatably coupled to a pair of bearings 122 that are axially separated (e.g., in a direction along the pivot axis 120). In some embodiments, the oscillating axle assembly 114 may include more or less than two bearings 122.

Both of the front frame section 110 and the rear frame section 112 include a mounting body, axle carrier, or mounting hub 124 that is coupled between the post 118 and the axle arms 104. Each of the mounting hubs 124 is pivotably or rotatably coupled to a pair of the axle arms 104, so that the axle arms 104 are allowed to move between the expanded position and the retracted position. The mounting hub 124 is pivotably or rotatably coupled to the post 118 via the bearings 122, which allows the mounting hub 124 to pivot or rotate relative to the center frame section 100 about the pivot axis 120. Because the post 118 is rigidly coupled (e.g., not capable of relative rotation) to the center frame section 100, the pivotable or rotatable coupling between the post 118 and the mounting hub 124 allows both the front frame section 110 (e.g., the axle arms 104 and the traction elements 16) and the rear frame section 112 (e.g., the axle arms 104 and the traction element 18) to independently pivot or rotate relative to the center frame section 100. In this way, for example, the front frame section 110 and the rear frame section 112 are allowed to independently oscillate relative to the center frame section 100 about the pivot axis 120, which allows each of the traction elements 16, 18 to follow the ground as the lift device 10 travels along the ground. Additionally, with the posts 118 extending outwardly from the pivot axis 120 (e.g., center axis) in a direction toward the traction elements 16, 18, space is provided for the pivotal or rotational movement between the center frame section 100 and both the front frame section 110 and the rear frame section 112, and the oscillating forces that the post 118 experiences are reduced.

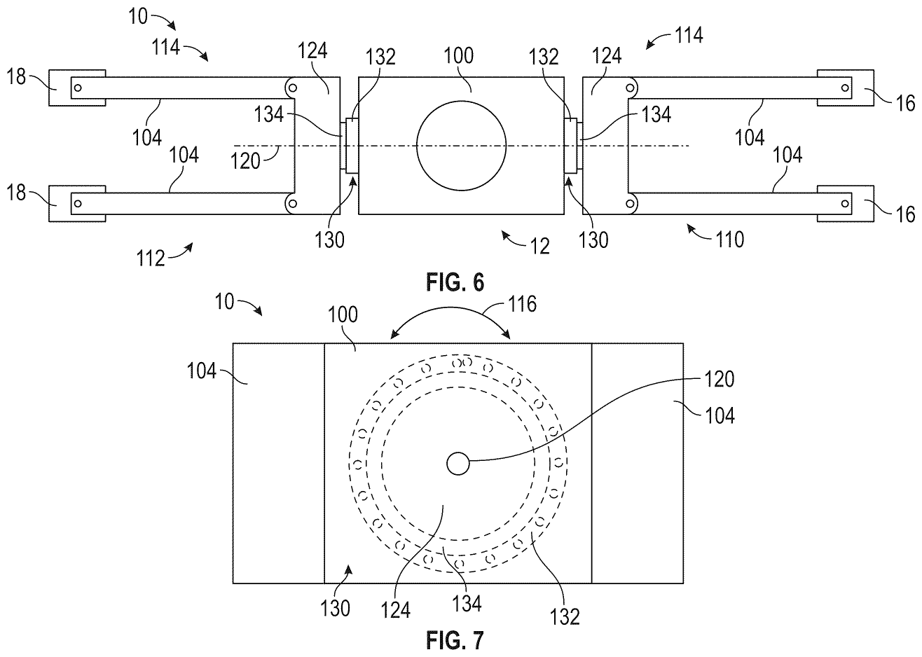

FIGS. 6 and 7 show an exemplary embodiment of the oscillating axle assembly 114 including a bearing 130 coupled between each of the front frame section 110 and the center frame section 100 and the rear frame section 112 and the rear frame section 112 and the center frame section 100. According to an exemplary embodiment, the bearing 130 is in the form of a double roller bearing, a turntable bearing, or an equivalent bearing structure. For example, each of the bearings 130 may include an outer bearing ring 132 that is coupled to the center frame section 100, and an inner bearing ring 134 that is coupled to a respective one of the front frame section 110 and the rear frame section 112. Specifically, the inner bearing ring 134 of the front frame section 110 may be coupled to the mounting hub 124 of the front frame section 110, and the inner bearing ring 134 of the rear frame section 112 may be coupled to the mounting hub 124 of the rear frame section 112. The outer bearing rings 132 may be coupled to the center frame section 100 so that the outer bearing rings 132 are fixed (e.g., prevented from rotating relative to) the center frame section 100. The inner bearing rings 134 may be coupled to the respective one of the mounting hubs 124 so that the inner bearing rings 134 are fixed (e.g., prevented from rotating relative to) the mounting hubs 124. In some embodiments, the outer bearing ring 132 may be coupled to the mounting hubs 124 and the inner bearing ring 134 may be coupled to the center frame section 100.

The outer bearing ring 132 in each of the bearings 130 is allowed to rotate relative to the inner bearing ring 134, which allows the mounting hubs 124 and the axle arms 104 coupled thereto to independently rotate or pivot relative to the center frame section 100 about the pivot axis 120. In this way, for example, the front frame section 110 and the rear frame section 112 are allowed to independently oscillate relative to the center frame section 100 about the pivot axis 120, which allows each of the traction elements 16, 18 to follow the ground as the lift device 10 travels along the ground.

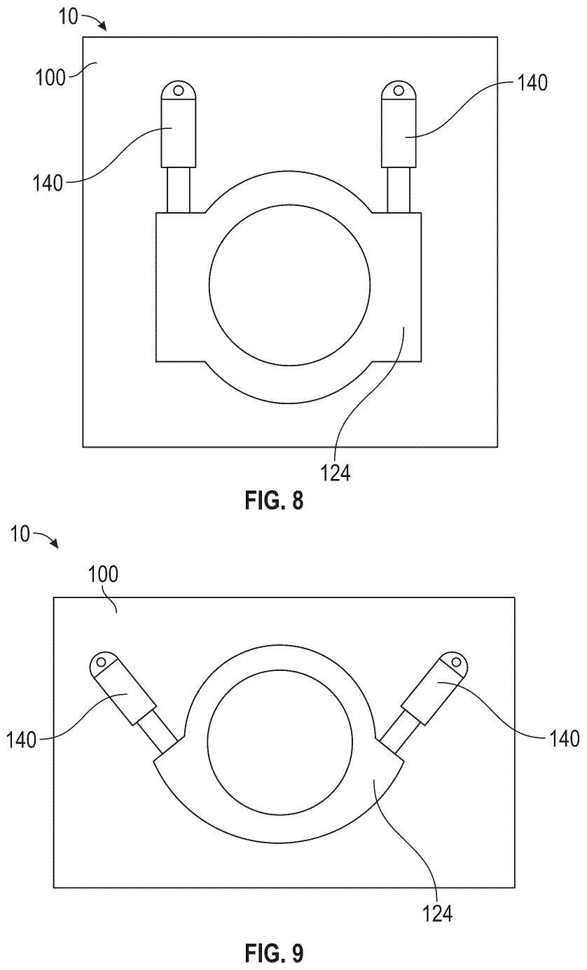

According to an exemplary embodiment, the oscillating axle assembly 114 may include one or more actuators that are configured to dampen and/or lock the oscillations between the center frame section 100 and both the front frame section 110 and the rear frame section 112. For example, at least one actuator may be coupled between the center frame section 100 and the front frame section 110, and at least one actuator may be coupled between the center frame section 100 and the rear frame section 112. FIG. 8 shows an exemplary embodiment of a pair of actuators 140 coupled between the mounting hub 124 (e.g., of the front frame section 110 or the rear frame section 112) and the center frame section 100. In some embodiments, the actuators 140 may be electromechanical actuators, a gearbox, a brake, or another locking device. In general, the actuators 140 may be configured to dampen oscillations so that the front frame section 110 and the rear frame section 112 pivot or rotate smoothly about the pivot axis 120. In some embodiments, the actuators 140 may be configured to lock the position of the mounting hub 124 relative to the center frame section 100, so that the front frame section 110 and/or the rear frame section 112 are prevented from oscillating, for example, when the platform assembly 92 is being raised.

In the embodiment of FIG. 8, the actuators 140 are positioned in a vertical orientation, with each of the actuators 140 being extending along a direction that is perpendicular to a ground on which the vehicle 10 travels or perpendicular to a top surface of the center frame section 100. In other embodiments, as shown in FIG. 9, the actuators 140 may be positioned in an angled or horizontal orientation (e.g., may be ninety degrees offset from the vertical orientation of FIG. 8), with each of the actuators 140 at an angle that is rotationally offset (e.g., an angle between ten and ninety degrees) from the vertical orientation of FIG. 8. In some embodiments, the angled or horizontal orientation may minimize the forces required to damped or lock the oscillation between the center frame section 100 and both the front frame section 110 and the rear frame section 112.

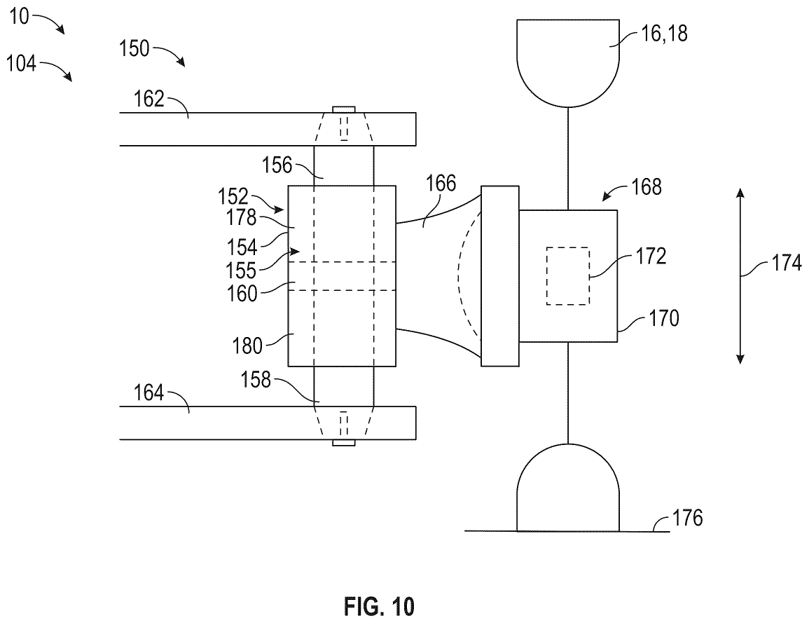

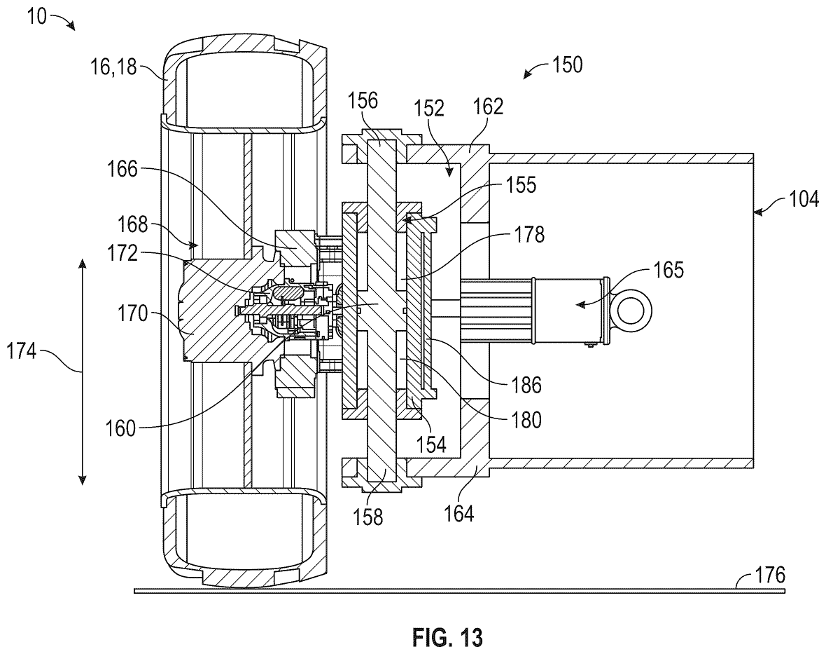

FIGS. 10-13 show an exemplary embodiment of a leveling assembly 150 on the lift device 10. In some embodiments, the leveling assembly 150 may be included on the lift device 10 in addition to the oscillating axle assembly 114 (e.g., the embodiment of FIGS. 4-5 or FIGS. 6-7). In some embodiments, the leveling assembly 150 may be included on the lift device 10 without the oscillating axle assembly 114. In general, the leveling assembly 150 is configured to allow a drive hub assembly 168 or a steering knuckle/spindle coupled to each of the tractive elements 16, 18 to independently translate vertically (e.g., in a direction perpendicular to the ground) so that the center frame section 100 of the chassis 12 may be leveled (e.g., oriented level relative to a direction of gravity or a horizontal plane) and/or the axle arms 104 may be operated with oscillating functionality. In other words, the axle arms 104 of the lift device 10 may be independently leveled relative to one another, even when the tractive elements 16, 18 are on uneven ground, to maintain the chassis 12 and the turntable 14 plumb relative to a vertical gravity axis. In some embodiments, one of the leveling assemblies 150 is included on the lift device 10 and provides leveling and ground-following capabilities.

As shown in FIGS. 10-13, the leveling assembly 150 is coupled between the axle arm 104 and one of the tractive elements 16, 18. It should be appreciated that each of the axle arms 104 may include one of the leveling assemblies 150 coupled between the axle arm 104 and the respective one of the tractive elements 16, 18. The leveling assembly 150 includes a height actuator 152 with a cylinder or barrel 154, a rod 155, and a piston 160 coupled to the rod 155. In the illustrated embodiment, the rod 155 includes a first rod portion 156 and a second rod portion 158 with the piston 160 arranged between the first rod portion 156 and the second rod portion 158. The piston 160 is enclosed within the cylinder 154. The first rod portion 156 is coupled to a first side of the piston 160 and extends from the piston 160, out of the cylinder 154, and couples to a first or upper portion 162 of the axle arm 104. The second rod is coupled to a second side of the piston 160, opposite to the first side, and extends from the piston, out of the cylinder 154, and couples to a second or lower portion 164 of the axle arm 104. In some embodiments, the height actuator 152 is a double-acting, double-rod hydraulic actuator.

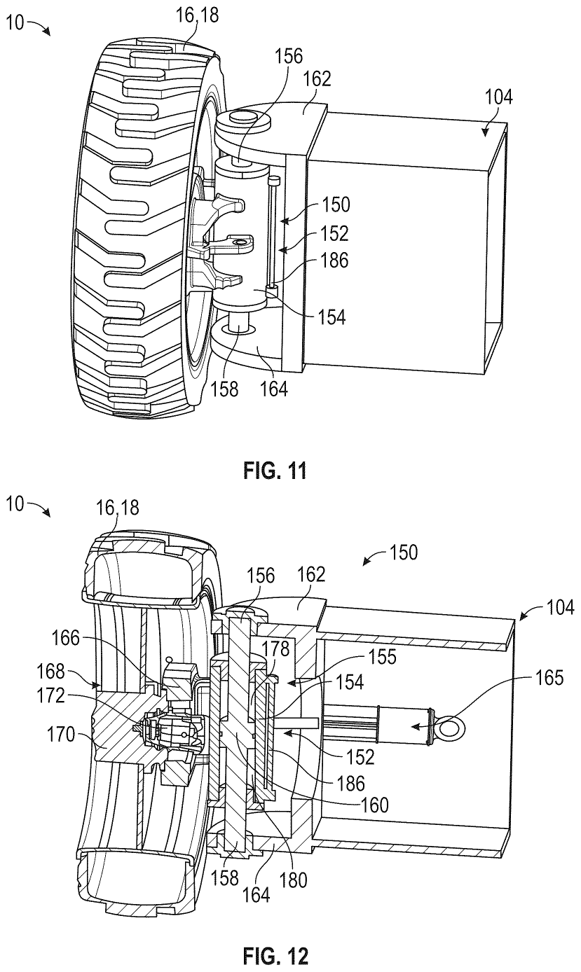

In some embodiments, a distal end of the first rod portion 156 is coupled to the first portion 162 of the axle arm 104 using a kingpin retainer. Similarly, a distal end of the second rod portion 158 is coupled to the second portion 164 of the axle arm 104 using a kingpin retainer. The first rod portion 156 and the second rod portion 158 may be rotationally fixed to the axle arm 104, and both the steering spindle 166 and the drive hub assembly 168 (and thereby the tractive element 16, 18) may be allowed to rotate about the piston 160, while the first rod portion 156 and the second rod portion 158 remain rotationally fixed, in response to a steering force. In other words, the cylinder 154 is allowed to rotate relative to the piston 160, and thereby relative to the axle arm 104, to enable steering of the tractive element (e.g., each of the tractive elements 16, 18 is independently steerable within the leveling assembly 150). For example, a steering actuator 165 is coupled between the axle arm 104 and the cylinder 154 (see, e.g., FIGS. 11-13). In some embodiments, the steering actuator 165 is directly coupled to the cylinder 154. The steering actuator 165 may be in the form of a piston-cylinder hydraulic actuator, an electric linear actuator, etc. In operation, the steering actuator 165 may be selectively actuated in a particular direction (e.g., extended or retracted) and the cylinder 154 may rotate in a particular direction (e.g., clockwise or counterclockwise) in response to the actuation of the steering actuator 165. In the illustrated embodiment, a center longitudinal axis of the rod 155 may define a steering axis for the tractive elements 16, 18. Each of the axle arms 104 may include a steering actuator 165 and one of the leveling assemblies 150 to enable independent steering of each of the tractive elements 16, 18, and independent leveling of each of the axle arms 104.

In some embodiments, the leveling assembly 150 is incorporated into or forms at least a part of a steering assembly for the tractive element (e.g., the tractive elements 16, 18). For example, the cylinder 154 is fixedly, rigidly/directly coupled to, or integrally formed with a steering spindle or hub 166, so that the cylinder 154 is prevented from rotating relative to the steering spindle 166. In some embodiments, the cylinder 154 is welded to the steering spindle 166. In some embodiments, the cylinder 154 is formed unitarily with the steering spindle 166 (e.g., as a single cast component), as shown in FIGS. 11-13. In some embodiments, the steering actuator 165 is coupled, or directly coupled, to the steering spindle 166. With the steering actuator 165 being directly coupled to or integrally formed with the steering spindle 166, actuation of the steering actuator 165 applied to the steering spindle 166 directly applies to the cylinder 154, and vice versa.

The steering spindle 166 is coupled between the cylinder 154 and a drive hub assembly 168. The drive hub assembly 168 includes a drive hub 170 that is coupled to the tractive element 16, 18 and a drive motor 172 that is configured to propel the tractive element 16, 18. With the steering spindle 166 being coupled between the cylinder 154 and the drive hub assembly 168, selective adjustment (e.g., extension or retraction) of the height actuator 152 results in vertical adjustment of the relative positioning between the axle arm 104 and the tractive element 16, 18. In other words, a vertical position of the tractive element 16, 18 along a height direction 174 may be selectively adjusted by the height actuator 152 so that the tractive element 16, 18 may be adjusted to maintain contact with varied slopes along the ground 176. In some embodiments, the steering spindle 166 is included as part of the drive hub assembly 168, and the steering actuator 165 is coupled between the axle arms 104 and the drive hub assembly 168.

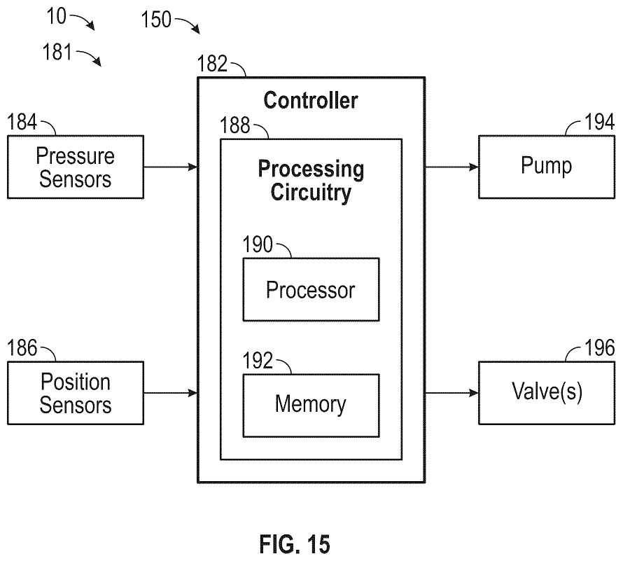

In some embodiments, the fluid flow within the height actuator 152 is configured to selectively adjust the vertical position of the tractive element 16, 18. For example, a first chamber 178 within the cylinder 154 is defined by the volume enclosed by the cylinder 154, the first rod portion 156, and the piston 160, and a second chamber 180 within the cylinder 154 is defined by the volume enclosed by the cylinder 154, the second rod portion 158, and the piston 160. The fluid flow into and out of the first chamber 178 and the second chamber 180, which controls the vertical position of the tractive element 16, 18, is controlled or metered by a control system 181, as shown in FIGS. 14 and 15 According to an exemplary embodiment, the leveling assembly 150 includes one or more sensors that are used to provide inputs/feedback to a controller 182. For example, the leveling assembly 150 may include one or more pressure sensors 184, and one or more position sensors 186. The one or more pressure sensors 184 may include a pressure sensor that measures a fluid pressure within the first chamber 178 (e.g., a first pressure sensor) and a pressure sensor that measures a fluid pressure within the second chamber 180 (e.g., a second pressure sensor). The one or more position sensors 186 may include a position sensor (e.g., a length sensor) that is configured to measure a length of the first rod portion 156 within the cylinder 154 (e.g., a distance between the piston 160 and an end of the cylinder 154 that the first rod portion 156 protrudes from), measure a length of the second rod portion 158 within the cylinder 154 (e.g., a distance between the piston 160 and an end of the cylinder 154 that the second rod portion 158 protrudes from), or measure a position of the piston 160 within the cylinder 154. In some embodiments, the position sensor 186 is coupled to an external surface or wall of the cylinder 154 and extends axially along the external surface or wall (e.g., along a full stroke of the piston 160), as shown in FIGS. 11-13.

With reference to FIGS. 10-15, the controller 182 is in communication with both of the pressure sensors 184 and the position sensors 186. The controller 182 includes a processing circuit 188 having a processor 190 and memory 192. The processing circuit 188 can be communicably connected to a communications interface such that the processing circuit 188 and the various components thereof can send and receive data via the communications interface. The processor 190 can be implemented as a general-purpose processor, an application specific integrated circuit (“ASIC”), one or more field programmable gate arrays (“FPGAs”), a group of processing components, or other suitable electronic processing components.

The memory 192 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 192 can be or include volatile memory or non-volatile memory. The memory 192 can include database components, object code components, script components, or any other type of information structure for supporting the various activities and information structures described in the present application. According to some embodiments, the memory 192 is communicably connected to the processor 190 via the processing circuit 188 and includes computer code for executing (e.g., by the processing circuit 188 and/or the processor 190) one or more processes described herein.

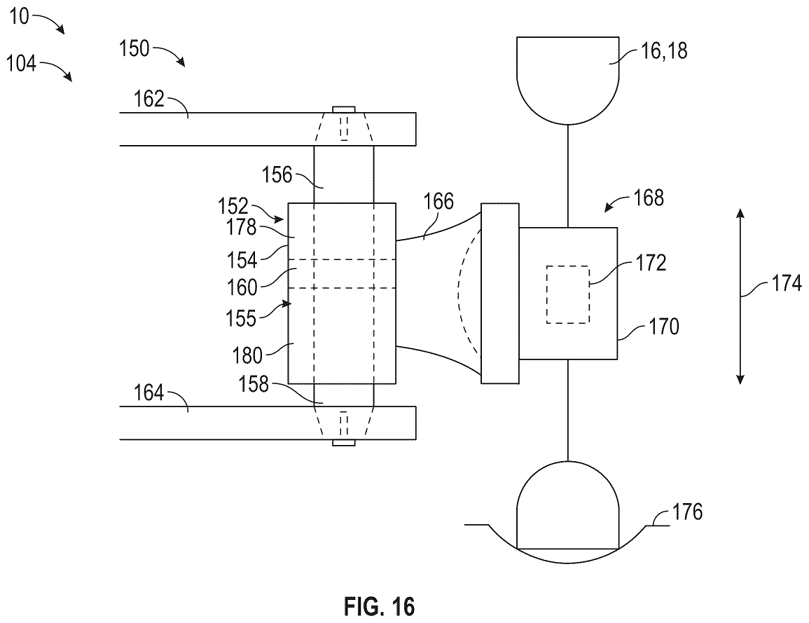

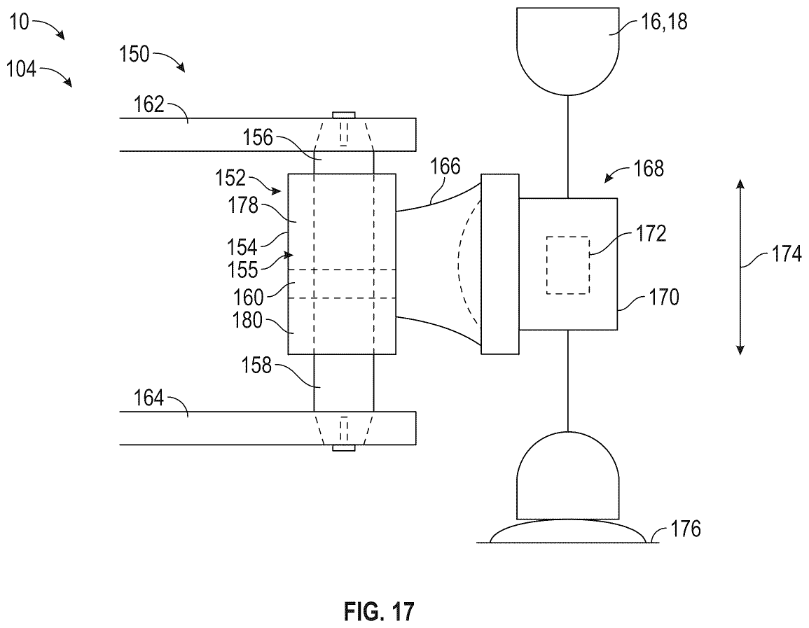

The signals from the pressure sensors 184 and the position sensors 186 are supplied as inputs to the controller 182, and the controller 182 is configured to control the position of the height actuator 152, and thereby the vertical position of the tractive element 16, 18, based on the signals from the pressure sensors 184 and the position sensors 186. In some embodiments, the lift device 10 includes a pump 194 and/or one or more valves 196, and the controller 182 is configured to control the pump 194 and/or the valve(s) 196 to control fluid flow to/from the first chamber 178 and the second chamber 180 (e.g., either connecting the chambers to the pump 194 or a tank 195 where the pump 194 draws fluid from), which results in movement of the cylinder 154 and the tractive element 16, 18 coupled thereto relative to the ground 176. For example, fluid flow may be provided into the second chamber 180 and removed from the first chamber 178 to move the cylinder 154, the steering spindle 166, the drive hub assembly 168, and the tractive element 16, 18 downward along the height direction 174 and maintain the tractive element 16, 18 in contact with the ground 176 when there is a hole or dip in the ground 176 (see, e.g., FIG. 16). Alternatively, fluid flow may be provided into the first chamber 178 and removed from the second chamber 180 to move the cylinder 154, the steering spindle 166, the drive hub assembly 168, and the tractive element 16, 18 upward along the height direction 174 and maintain the tractive element 16, 18 in contact with the ground when there is a bump or hill on the ground 176 (see, e.g., FIG. 17).

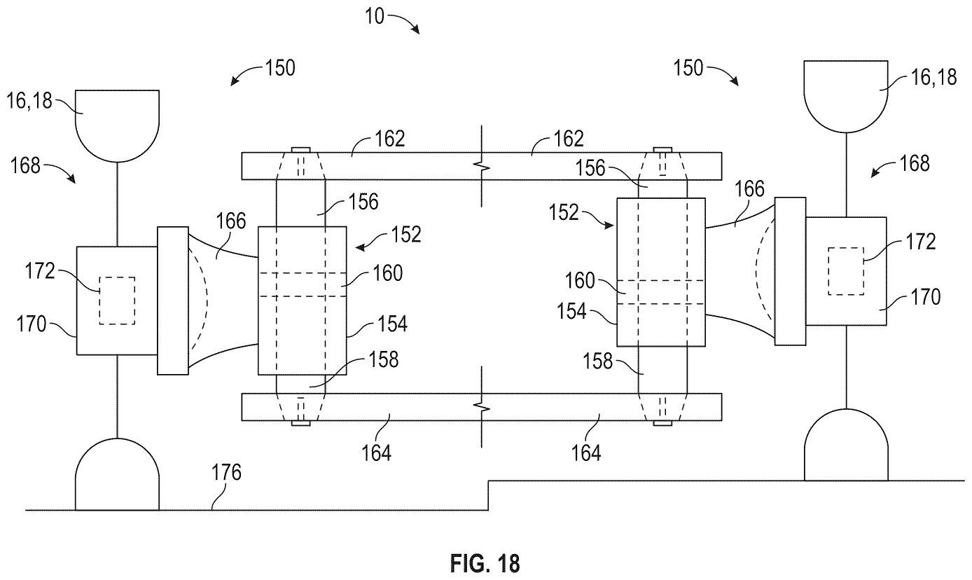

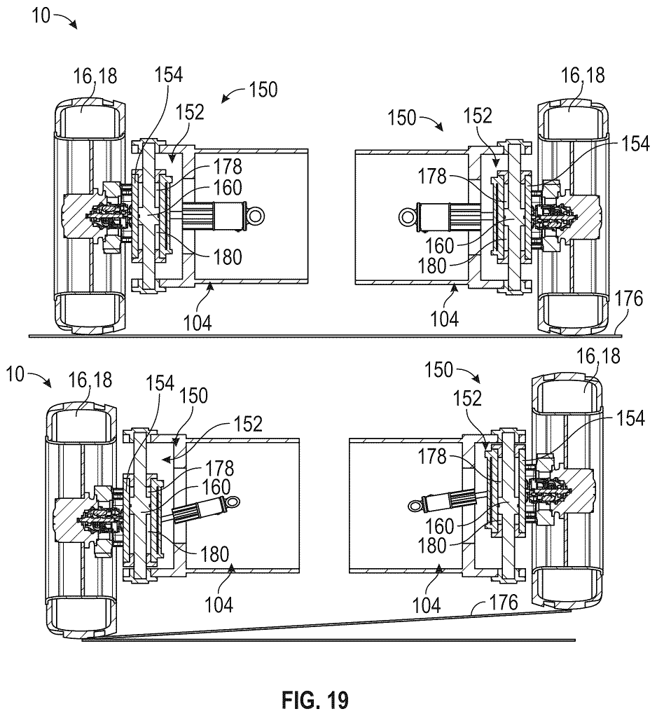

With each of the tractive elements 16, 18 and the axle arms 104 including one of the leveling assemblies 150 coupled thereto, the leveling assemblies 150 may compensate or accommodate for uneven ground in a front-to-back direction (e.g., left-front to left rear, left-front to right-rear, right-front to right-rear, and/or right-front to left-rear) and/or a side-to-side direction (e.g., left-front to right-front and/or right-front to right-rear), as shown in FIGS. 18 and 19.

The leveling assembly 150 may be used to selectively and independently adjust a position of each of the tractive elements 16, 18, which may be used to maintain a position of the chassis 12 and the front end 20 in a level position. In some embodiments, the controller 182 may be configured to perform static (e.g., stationary) leveling of the chassis 12 prior to elevating the platform assembly 92. Alternatively or additionally, the controller 182 may be configured to perform dynamic and active (e.g., moving) leveling of the chassis 12 while the lift device 10 is driving. Alternatively or additionally, the controller 182 may be configured to control the leveling assembly 150 on both of the front tractive elements 16 and both of the rear tractive elements 18 in an oscillating manner (e.g., similar to the functionality of the oscillating axle assembly 114). In some embodiments, the leveling assembly 150 may be incorporated between one of the axle arms 104 and one of the tractive elements 16, 18 to enable oscillating operation (e.g., maintaining all four tractive elements 16, 18 on the ground during operation).

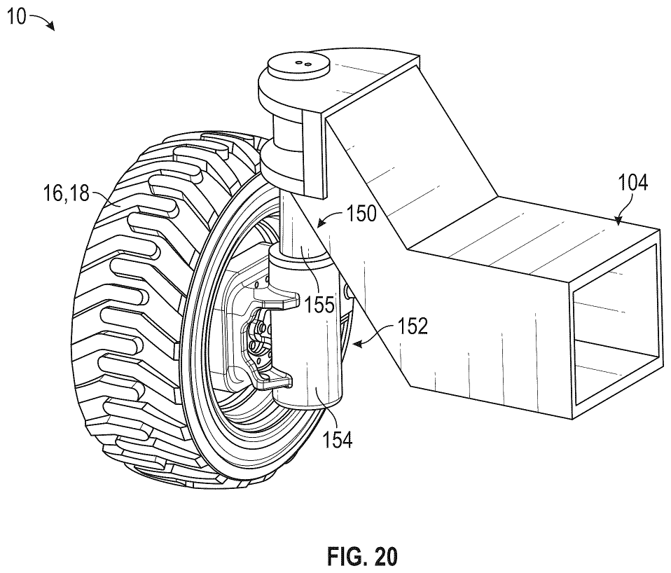

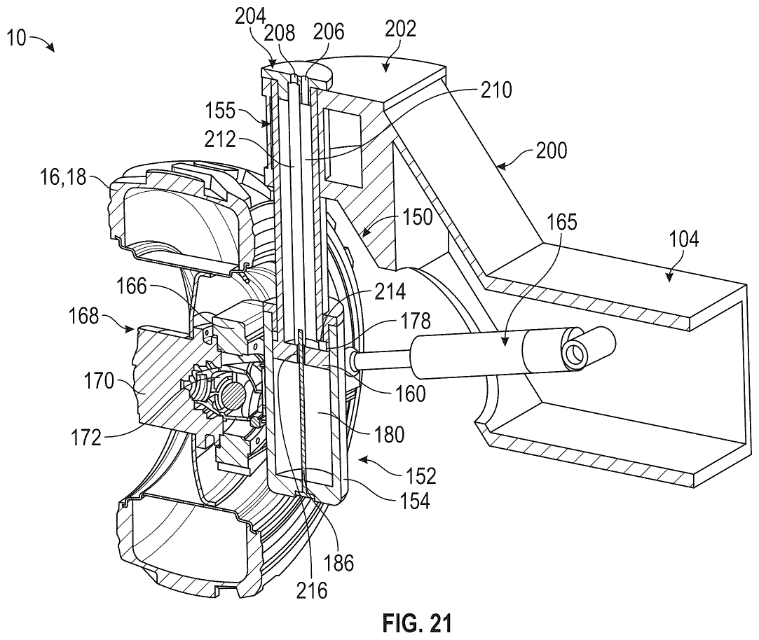

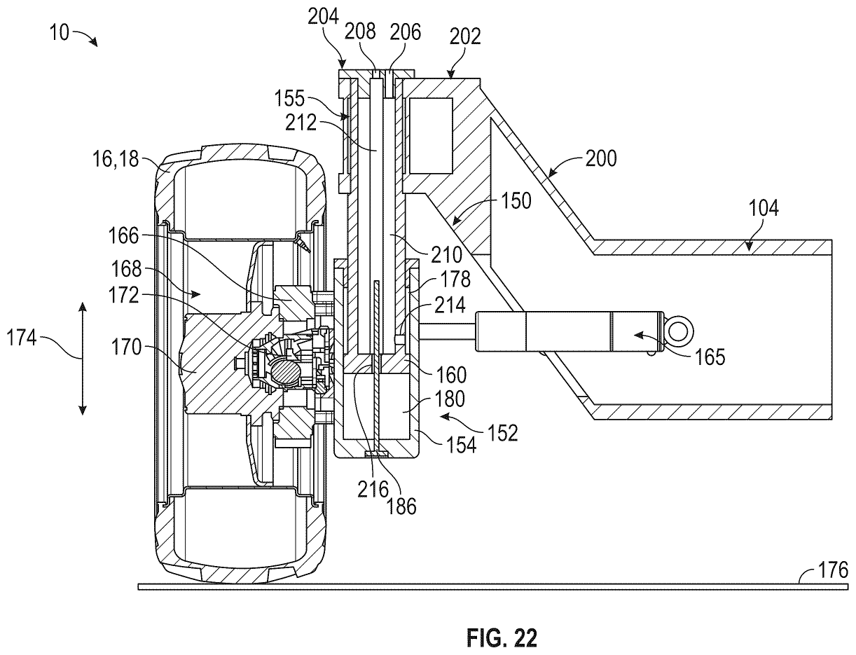

FIGS. 20-22 show an exemplary embodiment of the leveling assembly 150 on the lift device 10, where the configuration of the height actuator 152 is altered to accommodate a different structure of the axle arms 104. The leveling assembly 150 of FIGS. 20-22 is similar in design and functionality, with like elements identified using the same reference numerals, except as described herein or as apparent from the figures. In the illustrated embodiment, the axle arms 104 each include an angled portion 200 at a distal end thereof that angles or slopes upwardly (e.g., away from the ground) and a plate hub 202 extending outwardly from the end of the angled portion 200. The plate hub 202 is arranged generally parallel to the inner portion of the axle arm 104, but is raised above a top surface of the inner portion of the axle arm 104. With this configuration of the axle arm 104, the configuration of the height actuator 152 is modified to facilitate coupling to the plate hub 202 while still providing the same operation and functionality as the leveling assembly 150 described with respect to FIGS. 10-19.

As shown in FIGS. 20-22, the rod 155 only extends out of one side of the cylinder 154, rather than both sides as in the embodiment of FIGS. 10-19. In this configuration, the rod 155 protrudes through the end of the cylinder 154 (e.g., the end facing the plate hub 202) and a first end of the rod 155 is coupled to the plate hub 202 via a coupling plate 204. The coupling plate 204 couples the rod 155 to the plate hub 202, and thereby to the axle arms 104, so that the rod 155 is rotationally fixed to the axle arms 104. In other words, the rod 155 is prevented from rotating relative to the axle arms 104. The coupling plate 204 includes a first port 206 and a second port 208 that extend axially through (e.g., in a direction of a longitudinal axis of the rod 155) the coupling plate 204. As described herein, the first port 206 and the second port 208 provide fluid communication between the first chamber 178, the second chamber 180 and one of the pump 194 or the tank 195, for example, depending on the configuration of the one or more valves 196 and whether the leveling assembly 150 is raising or lowering tractive element and the axle arm 104.

In the illustrated embodiment, the piston 160 is arranged at second end of the rod 155 (e.g., an end axially opposite to the first end that is coupled to the axle arm 104). Like the embodiment of FIGS. 10-19, the piston 160 divides the internal volume of the cylinder 154 into the first chamber 178 and the second chamber 180. In the illustrated embodiment of FIGS. 20-22, the first chamber 178 is formed as an annular chamber the is enclosed by an external surface of the rod 155, an internal surface of the cylinder 154, and the piston 160. The second chamber 180 is enclosed by an internal surface of the cylinder 154 and the piston 160. The rod 155 includes a first internal passageway, bore, or channel, shown as first internal flow path 210, and a second internal passageway, bore, or channel, shown as second internal flow path 212. In the illustrated embodiment, the second internal flow path 212 is arranged radially outwardly relative to the first internal flow path 210, and the first internal flow path 210 extends along a longitudinal center of the rod 155.

The first port 206 is in fluid communication with the first chamber 178 through the first internal flow path 210 and a first rod port 214 that extends radially through an outer wall of the rod 155. For example, the first rod port 214 provides fluid communication between the first internal flow path 210 and the first chamber 178, and the first internal flow path 210 is in fluid communication with the first port 206. As such, the first port 206 acts as a flow port for providing fluid into the first chamber 178 (e.g., from the pump 194) and allowing fluid to flow out of the first chamber 178 (e.g., to the tank 195). The second port 208 is in fluid communication with the second chamber 180 through the second internal flow path 212 and a second rod port 216 that extend axially through the piston 160. For example, the second rod port 216 provides fluid communication between the second internal flow path 212 and the second chamber 180, and the second internal flow path 212 is in fluid communication with the second port 208. As such, the second port 208 acts as a flow port for providing fluid into the second chamber 180 (e.g., from the pump 194) and allowing fluid to flow out of the second chamber 180 (e.g., to the tank 195).

In some embodiments, the pressure sensors 184 may be integrated into or arranged within the first port 206 and the second port 208. For example, the pressure sensors 184 may be in the form of annular pressure/flow sensors that are arranged within the first port 206 and the second port 208 (e.g., one sensor per port). In this way, for example, the pressure sensors 184 may measure a pressure within the first chamber 178 and the second chamber 180, and/or a flow into/out of the first chamber 178 and the second chamber 180. In the illustrated embodiment, the position sensor 186 is coupled to the cylinder 154 and extend internally within an internal volume defined by the cylinder 154. For example, the position sensor 186 extends axially into and through the second chamber 180, through the second rod port 216 formed in the rod 155, and into the second internal flow path 212. The position sensor 186 extends axially along the through the internal volume of the cylinder 154 along a full stroke of the piston 160, which enables the position sensor 186 to measure a length or position of the rod 155 relative to the cylinder 154.

Like the embodiment of FIGS. 10-19, the leveling assembly 150 of FIGS. 20-22 is incorporated into or forms at least a part of a steering assembly for the tractive element (e.g., the tractive elements 16, 18), and the cylinder 154 is fixedly, rigidly/directly coupled to, or integrally formed with the steering spindle 166, so that the cylinder 154 is prevented from rotating relative to the steering spindle 166. The steering actuator 165 is coupled between the axle arm 104 and the cylinder 154 (and/or the steering spindle 166, and/or the drive hub assembly 168) (see, e.g., FIGS. 20-22), so the each of the tractive elements 16,18 is capable of being independently steered. In some embodiments, the steering actuator 165 is directly coupled to the cylinder 154 or the steering spindle 166. In the illustrated embodiment, a center longitudinal axis of the rod 155 may define a steering axis for the tractive elements 16, 18.

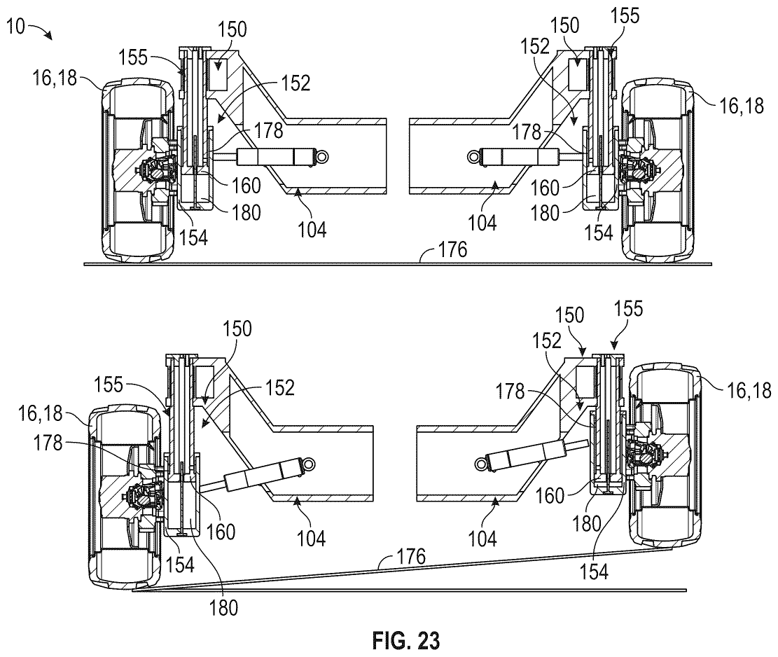

The control system 181 shown in FIGS. 14 and 15 may control the operation of the leveling assembly 150 shown in FIGS. 20-23 similar to the embodiment described with respect to FIGS. 10-19. For example, the signals from the pressure sensors 184 and the position sensors 186 are supplied as inputs to the controller 182, and the controller 182 is configured to control the position of the height actuator 152, and thereby the vertical position of the tractive element 16, 18, based on the signals from the pressure sensors 184 and the position sensors 186. As shown in FIG. 23, fluid flow may be provided into the second chamber 180 (e.g., by connecting the second port 208 to the pump 194) and removed from the first chamber 178 (e.g., by connecting the first port 206 to the tank 195) to move the cylinder 154, the steering spindle 166, the drive hub assembly 168, and the tractive element 16, 18 downward along the height direction 174 and maintain the tractive element 16, 18 in contact with the ground 176 when the ground 176 is uneven. Fluid flow may be provided into the first chamber 178 (e.g., by connecting the first port 206 to the pump 194) and removed from the second chamber 180 (e.g., by connecting the second port 208 to the tank 195) to move the cylinder 154, the steering spindle 166, the drive hub assembly 168, and the tractive element 16, 18 upward along the height direction 174 and maintain the tractive element 16, 18 in contact with the ground 176 is uneven.

The leveling assemblies of FIGS. 20-23 may be controlled independently to enable each wheel to compensate or accommodate uneven ground (e.g., dip in the ground, bump on the ground, etc.). Additionally, with each of the tractive elements 16, 18 and the axle arms 104 including one of the leveling assemblies 150 coupled thereto, the leveling assemblies 150 may compensate or accommodate for uneven ground in a front-to-back direction (e.g., left-front to left rear, left-front to right-rear, right-front to right-rear, and/or right-front to left-rear) and/or a side-to-side direction (e.g., left-front to right-front and/or right-front to right-rear), as shown in FIG. 23.

The leveling assembly 150 of FIGS. 20-23 may be used to selectively and independently adjust a position of each of the tractive elements 16, 18, which may be used to maintain a position of the chassis 12 and the front end 20 in a level position. In some embodiments, the controller 182 may be configured to perform static (e.g., stationary) leveling of the chassis 12 prior to elevating the platform assembly 92. Alternatively or additionally, the controller 182 may be configured to perform dynamic and active (e.g., moving) leveling of the chassis 12 while the lift device 10 is driving. Alternatively or additionally, the controller 182 may be configured to control the leveling assembly 150 on both of the front tractive elements 16 and both of the rear tractive elements 18 in an oscillating manner (e.g., similar to the functionality of the oscillating axle assembly 114).

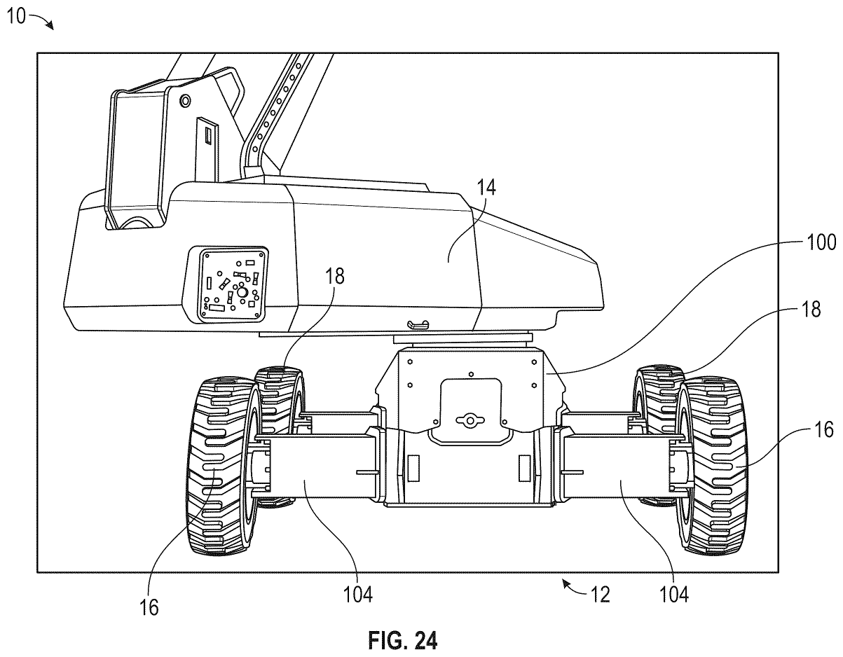

In some embodiments, the oscillating axle assembly 114 and/or the leveling assembly 150 may be installed on and applied to a lift device 10 that includes in-line extending axles, as shown in FIG. 24. For example, the systems and methods described herein relating to the oscillating axle assembly 114 and/or the leveling assembly 150 may be applied to an in-line extending axle lift device. In some embodiments, the oscillating axle assembly 114 and/or the leveling assembly 150 may be used on a lift device with fixed axles.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A lift device, comprising:
a chassis including a center frame section;
a turntable supported on and rotatably coupled to the center frame section;
a boom assembly coupled to the turntable;
a platform coupled to the boom assembly so that the boom assembly is configured to selectively raise and lower the platform;
an axle arm coupled to the center frame section so that the axle arm is extendable relative to the center frame section;
a tractive element coupled to the axle arm by a leveling assembly; and
a steering spindle coupled to the tractive element;
the leveling assembly includes:
a cylinder directly coupled to or integrally formed with the steering spindle;
a rod at least partially arranged within the cylinder and extending outwardly from the cylinder, wherein the rod includes a piston arranged within the cylinder that divides an internal volume of the cylinder into a first chamber and second chamber; and
a steering actuator coupled between the axle arm and the cylinder.

2. The lift device of claim 1, wherein a maximum operating height of the platform is greater than ninety feet.

3. The lift device of claim 1, wherein the rod includes an end that is fixedly coupled to the axle arm so that the rod is prevented from rotating relative to the axle arm.

4. The lift device of claim 3, wherein the cylinder is rotatably coupled to the rod so that actuation of the steering actuator results in rotation of the cylinder and thereby rotation of both the steering spindle and the tractive element to steer the tractive element.

5. The lift device of claim 3, wherein the rod includes a first end and a second end, and wherein both the first end and the second end are fixedly coupled to the axle arm.

6. The lift device of claim 1, further comprising a position sensor configured to measure a position of the rod relative to the cylinder.

7. The lift device of claim 6, wherein the position sensor is coupled to and extends along an external surface of the cylinder.

8. The lift device of claim 7, wherein the position sensor is coupled to the cylinder and extends along the internal volume of the cylinder.

9. The lift device of claim 1, wherein further comprising a first pressure sensor configured to measure a pressure within the first chamber and a second pressure sensor configured to measure a pressure within the second chamber.

10. The lift device of claim 1, further comprising a pump that draws fluid from a tank, and one or more valves arranged between the pump and the cylinder.

11. The lift device of claim 10, further comprising a controller in communication with the pump and the one or more valves, wherein the controller is configured to control operation of the valves and the pump to selectively supply fluid to or remove fluid from the first chamber and the second chamber to raise or lower the cylinder, and thereby the tractive element, relative to the axle arm.

12. The lift device of claim 1, wherein the rod includes a first internal flow path extending axially along the rod that is in fluid communication with the first chamber, and a second internal flow path extending axially along the rod that is in fluid communication with the second chamber.

13. The lift device of claim 12, wherein an end of the rod is fixedly coupled to the axle arm by a coupling plate.

14. The lift device of claim 13, wherein the coupling plate includes a first port in fluid communication with the first internal flow path and a second port in fluid communication with the second internal flow path.

15. The lift device of claim 14, wherein a pressure sensor is arranged within each of the first port and the second port.

16. The lift device of claim 1, further comprising a plurality of the axle arms, a plurality of the leveling assemblies, and a plurality of the tractive elements, wherein each of the axle arms is coupled to a respective one of the tractive elements, and wherein one of the leveling assemblies is coupled between each pair of the axle arms and the tractive elements.

17. A lift device, comprising:
a chassis;
a turntable supported on and rotatably coupled to the chassis;
a boom assembly coupled to the turntable;
a platform coupled to the boom assembly so that the boom assembly is configured to selectively raise and lower the platform;
an axle arm coupled to the chassis so that the axle arm is extendable relative to the chassis between a retracted position and an expanded position;
a tractive element coupled to the axle arm by a leveling assembly; and
a drive hub assembly coupled to the tractive element, wherein the drive hub assembly includes a steering spindle and a drive motor;
the leveling assembly includes:
a cylinder coupled to the drive hub;
a rod at least coupled to the cylinder and extending at least partially into
the cylinder, wherein the rod includes a piston arranged within the cylinder that divides an internal volume of the cylinder into a first chamber and second chamber; and
a steering actuator coupled between the axle arm and the drive hub assembly.

18. The lift device of claim 17, further comprising a controller in communication with a pump and one or more valves, wherein the controller is configured to control operation of the valves and the pump to selectively supply fluid to or remove fluid from the first chamber and the second chamber to raise or lower the cylinder, and thereby the tractive element, relative to the axle arm.

19. A lift device, comprising:
a chassis including a center frame section;
a turntable supported on and rotatably coupled to the center frame section;
a boom assembly coupled to the turntable;
a platform coupled to the boom assembly so that the boom assembly is configured to selectively raise and lower the platform;
an axle arm coupled to the center frame section so that the axle arm is extendable relative to the center frame section;
a tractive element coupled to the axle arm by a leveling assembly;
a steering spindle coupled to the tractive element;
the leveling assembly includes:
a cylinder directly coupled to or integrally formed with the steering spindle; and
a rod at least partially arranged within the cylinder and extending outwardly from the cylinder, wherein the rod includes a piston arranged within the cylinder that divides an internal volume of the cylinder into a first chamber and second chamber; and
a controller configured to selectively supply fluid to or remove fluid from the first chamber and the second chamber to raise or lower the cylinder, and thereby the tractive element, relative to the axle arm.

20. The lift device of claim 19, wherein the rod includes an end that is fixedly coupled to the axle arm so that the rod is prevented from rotating relative to the axle arm.
